(19) United States
(12) Patent Application Publication
(10) Pub. No.: US 2010/0143648 A1
(43) Pub. Date: Jun. 10, 2010

(54) FIBER-REINFORCED POLYMERIC CASING AND METHOD FOR MANUFACTURING THE SAME

(76) Inventors: Chia-Ming Tsai, TAIPEI CITY (TW); Chih-Chieh Chou, TAIPEI CITY (TW)

Correspondence Address: NORTH AMERICA INTELLECTUAL PROPERTY CORPORATION, P.O. BOX 506, MERRIFIELD, VA, 22116, US

(21) Appl. No.: 12/618,789

(22) Filed: Nov. 16, 2009

(30) Foreign Application Priority Data
Dec. 4, 2008 (TW) 097147143

(51) Int. Cl. B32B 27/04; B29C 45/14; B32B 27/00; B32B 15/08

(52) U.S. Cl. 428/138; 264/263; 428/300.7; 428/301.4; 428/301.1

(57) ABSTRACT

This invention discloses a fiber-reinforced polymeric casing and a method for manufacturing the same. According to this invention, the casing includes a multi-layer structure, an intermedium film, and a structural part. The multi-layer structure is formed by shaping and stacking up a plurality of layers of fiber-reinforced polymeric mats. The intermedium film is disposed on a surface of the multi-layer structure. The structural part includes a polymer and is one-step molded on the intermedium film together with the multi-layer structure.

### CROSS-REFERENCE TO RELATED APPLICATIONS

This Non-provisional application claims priority under 35 U.S.C. §119(a) on Patent Application No(s). 097147143 filed in Taiwan, Republic of China Dec. 4, 2008, the entire contents of which are hereby incorporated by reference.

### BACKGROUND OF THE INVENTION

1. Field of the Invention

The invention relates to a casing and a method for manufacturing the same and, more particularly, to a fiber-reinforced polymeric casing and a method for manufacturing the same.

2. Description of the Related Art

To reduce weight, a plurality of polymers, such as thermosetting resin or thermoplastic resin, have been widely applied to casings of electronic devices. Further, application of fiber-reinforced thermosetting polymers and fiber-reinforced thermoplastic polymers has also been gradually widened in order to improve strength of a casing made of a polymer. However, different manufacturing processes are needed in accordance in using the fiber-reinforced thermosetting polymers or the fiber-reinforced thermoplastic polymers to manufacture a casing.

When the fiber-reinforced thermosetting polymer is used to manufacture a casing, a vacuum molding process is generally performed. In the vacuum molding process, a fiber-reinforced thermosetting polymeric mat is first cut and then is attached to an inner wall of a mold. The mold where the fiber-reinforced thermosetting polymeric mat is attached is then disposed in a vacuum pan; and further, the vacuum pan is performed a vacuum pumping process and risen to a proper temperature. Finally, the mold where the fiber-reinforced thermosetting polymeric mat is attached is taken away from the vacuum pan, and the casing manufactured by processing the fiber-reinforced thermosetting polymeric mat is separated from the mold.

When the fiber-reinforced thermoplastic polymer is used to manufacture a casing, a hot press molding process is generally performed. In the hot press molding process, a fiber-reinforced thermoplastic polymeric mat is first cut and then is attached to an inner wall of a lower mold. An upper mold and the lower mold are then pressed to perform the hot press molding. Finally, the molded fiber-reinforced thermoplastic polymeric casing is separated from the lower mold.

If a structural part needs to be disposed at an inner wall of a fiber-reinforced polymeric casing, the structural part is joined or attached to the inner wall of the fiber-reinforced polymeric casing in a dispensing mode or via twin adhesive. However, the join between the structural part disposed at the inner wall of the fiber-reinforced polymeric casing and the casing fails to stand the subsequent long-term use.

In the present, the molded fiber-reinforced polymeric casing is first disposed in an injection molding mold, and the structural part is then molded on the inner wall of the fiber-reinforced polymeric casing via injection molding. According to the above method, the join strength between the structural part and the casing can be improved. However, the originally molded fiber-reinforced polymeric casing is easy to have problems in appearance, deformation or others in the injection molding process. Further, a group of molds is needed to mold the fiber-reinforced polymeric casing, and another group of modes is needed to mold the structural part on the inner wall of the fiber-reinforced polymeric casing, which makes the whole manufacturing cost higher.

With continuous development of the fiber-reinforced polymers applied to the casing manufacture, the manufacturing technique that the fiber-reinforced polymeric casing and the structural part are one-step molded with the better join strength is still not provided.

### BRIEF SUMMARY OF THE INVENTION

One objective of this invention is to provide a fiber-reinforced polymeric casing and a method for manufacturing the same. According to this invention, the casing and a structural part thereof are one-step molded thus to effectively reduce the manufacturing cost of the casing and to improve the join strength between the casing and the structural part.

According to one aspect of the invention, the invention provides a fiber-reinforced polymeric casing. According to one preferred embodiment of the invention, the fiber-reinforced polymeric casing includes a multi-layer structure, an intermedium film, and a structural part. The multi-layer structure is formed by shaping and stacking up a plurality of layers of fiber-reinforced polymeric mats. The intermedium film is disposed on a surface of the multi-layer structure. The structural part includes a polymer and is one-step molded on the intermedium film together with the multi-layer structure. In one embodiment, the intermedium film may be made of a metal material or a plastic material. In one embodiment, the structural part may be formed via an injection molding process.

According to another aspect of the invention, the invention provides a method for manufacturing a fiber-reinforced polymeric casing. According to one preferred embodiment of the invention, a plurality of layers of fiber-reinforced polymeric mats is first shaped and stacked up to build a multi-layer structure. An intermedium film is then disposed on a surface of the multi-layer structure. Finally, an one-step molding process is performed to form a structural part including a polymer on the intermedium film and the multi-layer structure. In one embodiment, the intermedium film may be made of a metal material or a plastic material. In one embodiment, the structural part may be formed via an injection molding process.

These and other features, aspects, and advantages of the present invention will become better understood with regard to the following description, appended claims, and accompanying drawings.

### BRIEF DESCRIPTION OF THE DRAWINGS

FIG. 1A is a schematic diagram showing a fiber-reinforced polymeric casing and a section thereof according to one preferred embodiment of the invention;

FIG. 1B is a schematic diagram showing a fiber-reinforced polymeric casing and a section thereof according to another preferred embodiment of the invention; and

FIGS. 2A to 2D are sectional schematic diagrams corresponding to a method for manufacturing a fiber-reinforced polymeric casing according to one preferred embodiment of the invention.

### DETAILED DESCRIPTION OF THE INVENTION

This invention provides a fiber-reinforced polymeric casing and a method for manufacturing the same. According to the invention, the fiber-reinforced polymeric casing and a structural part thereof are one-step molded and better join strength therebetween is provided. Preferred embodiments of the invention are described in detail hereinbelow. Thereby, the features, aspects, advantages, and feasibility of mass production of products are described.

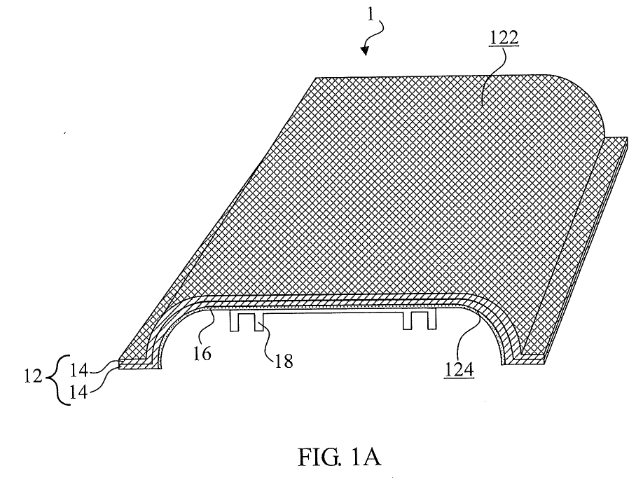

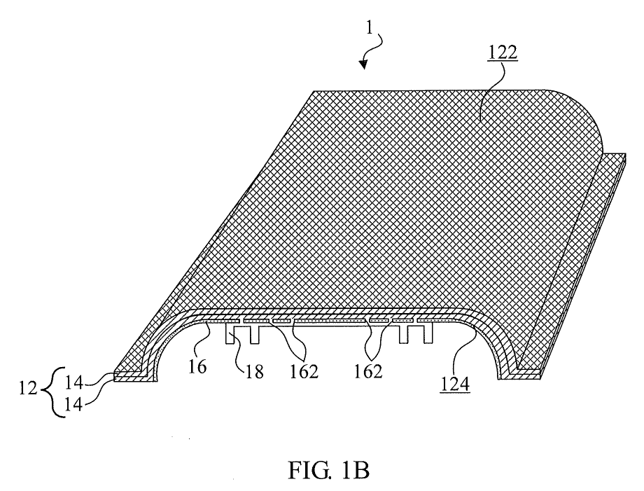

FIG. 1A is a schematic diagram showing a fiber-reinforced polymeric casing 1 and a section thereof according to one preferred embodiment of the invention. Please refer to FIG. 1A. In this preferred embodiment of the invention, the fiber-reinforced polymeric casing 1 includes a multi-layer structure 12, an intermedium film 16, and a structural part 18.

In FIG. 1A, the multi-layer structure 12 is formed by shaping and stacking up a plurality of layers of fiber-reinforced polymeric mats 14. The shaped multi-layer structure 12 has an outer surface 122 and a curved inner surface 124.

In one embodiment, the fiber-reinforced polymeric mats 14 may include a thermosetting polymer or a thermoplastic polymer.

In FIG. 1A, the intermedium film 16 is disposed on the inner surface 124 of the multi-layer structure 12. The structural part 18 includes a polymer and is disposed on the intermedium film 16 as shown in FIG. 1A. When the structural part 18 is molded, the multi-layer structure 12 is also molded at the same time. That is, the fiber-reinforced polymeric casing 1 and the structural part 18 thereof are molded together, which is called one-step molding.

In one embodiment, the structural part 18 may be molded on the intermedium film 16 via an injection molding process. In the injection molding process, the multi-layer structure 12 may be molded together.

Because of using the intermedium film 16, problems in appearance, deformation, or others of the fiber-reinforced polymeric casing 1 can be avoided during the molding process. The intermedium film 16 allows the structural part 18 to be firmly fixed to a surface of the casing 1. In addition, considering the design, the intermedium film 16 can strengthen the whole rigidity of the casing 1 or allow the casing 1 to have other physical characteristics by selecting a proper material to manufacture the intermedium film 16, such as protection against electromagnetic interference. In one embodiment, the intermedium film 16 may be made of a metal material or a plastic material.

Please refer to FIG. 1B. In another preferred embodiment, the intermedium film 16 can have a plurality of through holes 162 to further improve the join strength between the structural part 18 and the casing 1. When a plurality of the structural parts 18 are molded via an injection molding process, a part of the injected polymer is injected into the through holes 162 to be joined to the intermedium film 16 or the multi-layer structure 12. Thereby, the join strength between the structural parts 18 and the casing 1 is improved. Whether the through holes 162 need to be formed on the intermedium film 16 is determined by the manufacturing material of the intermedium film 16. When the bridging force between the intermedium film 16 and the structural parts 18 or between the intermedium film 16 and the multi-layer structure 12 is not enough, the design of the through holes is needed. In the other word, the design of the through holes may be omitted when the intermedium film 16, the structural parts 18, and the multi-layer structure 12 are all made of a polymer.

The elements in FIG. 1B having the same marks with that in FIG. 1A are material layers mentioned above. Therefore. They are not described for a concise purpose.

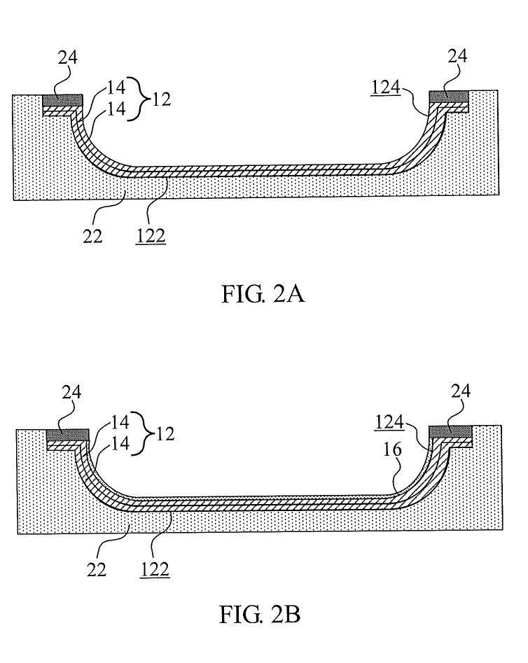

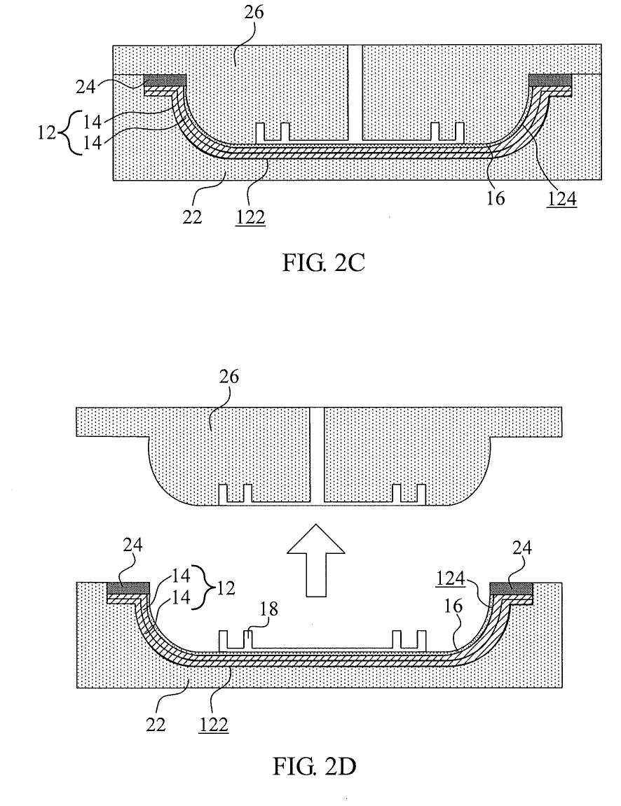

FIGS. 2A to 2D are sectional schematic diagrams corresponding to a method for manufacturing a fiber-reinforced polymeric casing according to one preferred embodiment of the invention. Please refer to FIGS. 2A to 2D. The method is described hereinbelow in detail.

According to the method in this embodiment, a plurality of layers of fiber-reinforced polymeric mats 14 are first shaped and stacked up to build a multi-layer structure 12. The shaped multi-layer structure 12 has an outer surface 122 and a curved inner surface 124. In one embodiment, in FIG. 2A, the layers of the fiber-reinforced polymeric mats 14 are first cut and then are disposed on an inner wall of a lower mold 22, and they are stacked to a needed thickness. In a practical application, a fixed plate 24 may be disposed at an edge of the multi-layer structure 12 to help shaping the multi-layer structure 12.

In another preferred embodiment, the step of shaping and stacking up the layers of the fiber-reinforced polymeric mats 14 further includes the step of immersing the fiber-reinforced polymeric mats 14 in resin.

Please refer to FIG. 2B, an intermedium film 16 is disposed on the inner surface 124 of the multi-layer structure 12 according to the method in this embodiment. In one embodiment, the intermedium film 16 may be made of a metal material or a plastic material.

Finally, according to the method in this embodiment, an one-step molding process is performed to form a structural part 18 including a polymer on the intermedium film 16 and the multi-layer structure 12. In one embodiment, the structural part 18 may be molded on the intermedium film 16 via an injection molding process. The structural part 18 molded via the injection molding process is shown in FIG. 2C and FIG. 2D. An upper mold 26 and the lower mold 22 where the material layers are disposed as shown in FIG. 2B are closed, and the injection molding process is then performed. In the injection molding process, the multi-layer structure 12 is molded together. Afterwards, the upper mold 26 and the lower mold 22 are separated from each other as shown in FIG. 2D. The structural part 18 is molded on the intermedium film 16. Then, the fiber-reinforced polymeric casing 1 as shown in FIG. 1A is completed after removing the lower mold 22.

In another preferred embodiment, a plurality of through holes 162 can be formed at the intermedium film 16 beforehand as shown in FIG. 1B. When the structural parts 18 are molded via the injection molding process, a part of the injected polymer is injected into the through holes 162 to be joined to the intermedium film 16 or the multi-layer structure 12. Thereby, the join strength between the structural parts 18 and the casing 1 is improved.

In addition, the above one-step molding process can be replaced by an injection molding process in which one fixed mold corresponds to two or more than two movable molds. For example, the upper mold 26 may be the fixed mold and two lower molds (the movable molds) 22 may be alternately used to perform the injection molding process with the upper mold 26. In this injection molding design, when one lower mold is operated for molding, the other lower mold fetches elements and performs pre-operation for the injection molding process. Thereby, the whole manufacturing operation is safe and the manufacturing efficiency can be improved.

According to the preferred embodiments of the invention, the fiber-reinforced polymeric casing has a one-step molding advantage and does not have problems in appearance, deformation, or others happened in the prior art. In addition, for the manufacturing design, the injection molding process in which one fixed mold corresponds to two or more than two movable molds can be performed to greatly improve feasibility of the mass production of the products.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for manufacturing a fiber-reinforced polymeric casing, the method comprising the following steps of:
(a) shaping and stacking up a plurality of layers of fiber-reinforced polymeric mats to build a multi-layer structure;
(b) disposing an intermedium film on a surface of the multi-layer structure; and
(c) performing an one-step molding process to form a structural part including a polymer on the intermedium film and the multi-layer structure.

2. The method according to claim 1, wherein the step (a) further comprises the following step of:
immersing the layers of the fiber-reinforced polymeric mats in resin.

3. The method according to claim 1, wherein the step (c) is performed via an injection molding process.

4. The method according to claim 3, wherein the intermedium film has a plurality of through holes, a part of the polymer and the intermedium film are joined together via the through holes in the injection molding process.

5. The method according to claim 3, wherein the intermedium film has a plurality of through holes, a part of the polymer and the multi-layer structure are joined together via the through holes in the injection molding process.

6. The method according to claim 1, wherein the polymer is a plastic material.

7. The method according to claim 1, wherein the intermedium film is made of a metal material or a plastic material.

8. A fiber-reinforced polymeric casing comprising:
a multi-layer structure formed by shaping and stacking up a plurality of layers of fiber-reinforced polymeric mats;
an intermedium film disposed on a surface of the multi-layer structure; and
a structural part including a polymer and one-step molded on the intermedium film together with the multi-layer structure.

9. The fiber-reinforced polymeric casing according to claim 8, wherein the fiber-reinforced polymeric mats include a thermosetting polymer or a thermoplastic polymer.

10. The fiber-reinforced polymeric casing according to claim 8, wherein the intermedium film is made of a metal material or a plastic material.

11. The fiber-reinforced polymeric casing according to claim 8, wherein the structural part is formed via an injection molding process.

12. The fiber-reinforced polymeric casing according to claim 11, wherein the intermedium film has a plurality of through holes, a part of the polymer and the intermedium film are joined together via the through holes.

13. The fiber-reinforced polymeric casing according to claim 11, wherein the intermedium film has a plurality of through holes, a part of the polymer and the multi-layer structure are joined together via the through holes.
